(19) United States
(12) Patent Application Publication
(10) Pub. No.: US 2010/0231110 A1
(43) Pub. Date: Sep. 16, 2010

(54) DOOR SUPPORT DEVICE FOR REFRIGERATOR AND REFRIGERATOR COMPRISING THE SAME

(76) Inventor: Chang-Bong Choi, Changwon City (KR)

Correspondence Address: BIRCH STEWART KOLASCH & BIRCH, PO BOX 747, FALLS CHURCH, VA, 22040-0747, US

(21) Appl. No.: 12/377,843

(22) PCT Filed: Dec. 21, 2006
(86) PCT No.: PCT/KR06/05633

§ 371 Date: Feb. 17, 2009

(51) Int. Cl. F25D 23/02; E05D 5/04; E05D 5/12; E05D 11/00

(52) U.S. Cl. 312/405; 16/382; 16/250; 16/251

(57) ABSTRACT

The present invention relates to a door supporting device for a refrigerator. According to the present invention, a door supporting device for a refrigerator including a main body formed with a predetermined storage space therein and a door for selectively opening or closing the storage space comprises a hinge plate extending from one side of a front surface of the main body and having a downwardly extending hinge pin, and an installing recess formed by inwardly depressing a portion of an upper surface of the door by a predetermined depth and formed with a hinge hole therein, wherein the hinge plate is securely seated in the installing recess when the hinge pin is inserted into the hinge hole. Accordingly, a front external appearance of the refrigerator can be further simplified and the door supporting device can be prevented from being damaged.

### TECHNICAL FIELD

The present invention relates to a refrigerator, and more particularly, to a door supporting device for a refrigerator which pivotally supports a refrigerator door on a main body of the refrigerator, and a refrigerator including the same.

### BACKGROUND ART

FIG. 6 is an exploded perspective view of a door supporting device for a refrigerator according to the related art.

As shown in the figure, a predetermined storage space 10S is defined within a refrigerator main body 10, and a door 10D is provided to selectively open/close the storage space 10S. The door 10D is installed to pivot on an end thereof at one side of the main body 10 in a front and rear direction of the main body 10.

To this end, hinge plates 11 are fixed to predetermined portions of front ends of upper and lower surfaces of the refrigerator main body 10, respectively. A front end of each hinge plate 11 protrudes forward beyond the main body 10 by a predetermined length, and a hinge pin 13 extending in an opposite direction by a predetermined length is provided at a tip end of the hinge plate 11.

Further, hinge holes 15 are formed on portions of upper and lower surfaces of the door 10D corresponding to the hinge pins 13, respectively. The hinge pins 13 are inserted into the hinge holes 15, respectively. Accordingly, the door 10D is pivoted on the hinge pins 13 inserted respectively in the hinge holes 15 in a front and rear direction of the main body 10.

Furthermore, a hinge cover 17 is provided to cover the hinge plate 11 fixed to the upper surface of the main body 10. The hinge cover 17 is fixed to one side of the upper surface of the main body 10 in a state where the hinge cover 17 covers the hinge plate 11.

However, the door supporting device for a refrigerator according to the related art has the following problems.

As described above, since the hinge cover 17 covers the hinge plate 11, the cover protrudes upwardly from the upper surfaces of the main body 10 and the door 10D. Therefore, the hinge cover 17 is exposed forward of the main body 10, so that a front external appearance of the refrigerator becomes complicated.

In addition, since the hinge cover 17 protrudes upwardly from the upper surfaces of the main body 10 and the door 10D as described above, it is likely that the hinge assembly may be damaged in the process of carrying or installing the refrigerator.

### DISCLOSURE OF INVENTION

Technical Problem

Accordingly, the present invention is conceived to solve the aforementioned problems in the related art. An object of the present invention is to provide a door supporting device configured to allow an external appearance of a refrigerator to be simplified, and a refrigerator including the same.

Another object of the present invention is to provide a door supporting device configured to prevent itself from being damaged, and a refrigerator including the same.

Technical Solution

According to an aspect of the present invention for achieving the objects, there is provided a door supporting device for a refrigerator including a main body formed with a predetermined storage space therein and a door for selectively opening or closing the storage space, comprising: a hinge plate extending from one side of a front surface of the main body and having a downwardly extending hinge pin; and an installing recess formed by inwardly depressing a portion of an upper surface of the door by a predetermined depth and formed with a hinge hole therein, wherein the hinge plate is securely seated in the installing recess in a state where the hinge pin is inserted into the hinge hole.

In one embodiment of the invention, the hinge plate comprises: a fixing portion secured to one side of the front surface of the main body; and an extending portion extending forward from a front surface of the fixing portion and formed with the hinge pin on a surface thereof, wherein the fixing portion and the extending portion are placed within the installing recess.

According to another aspect of the present invention for achieving the objects, there is provided a door supporting device for a refrigerator including a main body formed with a predetermined storage space therein and a door for selectively opening or closing the storage space, comprising: a hinge plate extending from one side of a front surface of the main body and having a downwardly extending hinge pin; and a covering section formed by causing a portion of an upper surface of the door to protrude upwardly to prevent the hinge plate from being exposed forward of the door in a state where the hinge pin is inserted into a hinge hole formed at one side of the upper surface of the door.

In one embodiment of the invention, other portions of the door than a portion of the upper surface of the door brought into close contact with the hinge plate and portions adjacent to the portion brought into close contact with the hinge plate protrude upwardly to thereby form the covering section.

In another embodiment of the invention, the hinge plate comprises: a fixing portion secured to one side of the front surface of the main body; and an extending portion extending forward from a front surface of the fixing portion and formed with the hinge pin on a surface thereof, wherein the fixing portion and the extending portion are placed within the installing recess.

In another embodiment of the invention, there is further comprising a front cover for covering the fixing portion of the hinge plate.

In another embodiment of the invention, the main body is formed with first and second seating recesses on a front surface thereof, the fixing portion is seated in the first seating recess, and the front cover is seated in the second seating recess in which the first seating recess is defined.

In another embodiment of the invention, there is further comprising an upper cover for covering the extending portion of the hinge plate.

According to another aspect of the present invention for achieving the objects, there is provided a refrigerator, comprising: a main body formed with a predetermined storage space therein; a door for selectively opening or closing the storage space; and a door supporting device according to any one of claims 1 to 5 for pivotally supporting the door on the main body.

In one embodiment of the invention, door supporting device further comprises: a front cover for covering the fixing portion of the hinge plate; and an upper cover for covering the extending portion of the hinge plate.

In another embodiment of the invention, the fixing portion is securely seated in a first seating recess formed by relatively rearward depressing a portion of a front surface of the main body.

In another embodiment of the invention, a front surface of the front cover is flush with a front surface of the main body when the front cover is seated in a second seating recess formed by relatively rearward depressing a portion of a front surface of the main body including the first seating recess.

In another embodiment of the invention, the storage space defined in the main body is formed into a pair of storage spaces partitioned from side to side, and the door is pivoted in a front and rear direction by the door supporting device in such a state that a free end thereof is opposite to a free end of the other door.

Advantageous Effects

According to the present invention so configured, there are advantages in that a front external appearance of a refrigerator can be further simplified and the refrigerator can be prevented from being damaged.

### BRIEF DESCRIPTION OF DRAWINGS

The above and other objects, features and advantages of the present invention will become apparent from the following descriptions of preferred embodiments given in conjunction with the accompanying drawings, in which:

FIG. 1 is an exploded perspective view showing a preferred embodiment of a door supporting device according to the present invention;

FIGS. 2 to 5 are views showing an operating process of assembling the preferred embodiment according to the present invention; and

FIG. 6 is an exploded perspective view of a door supporting device according to the related art.

### BEST MODE FOR CARRYING OUT THE INVENTION

Hereinafter, the door supporting device and the refrigerator including the same according to the preferred embodiment of the present invention will be described in more detail with reference to accompanying drawings.

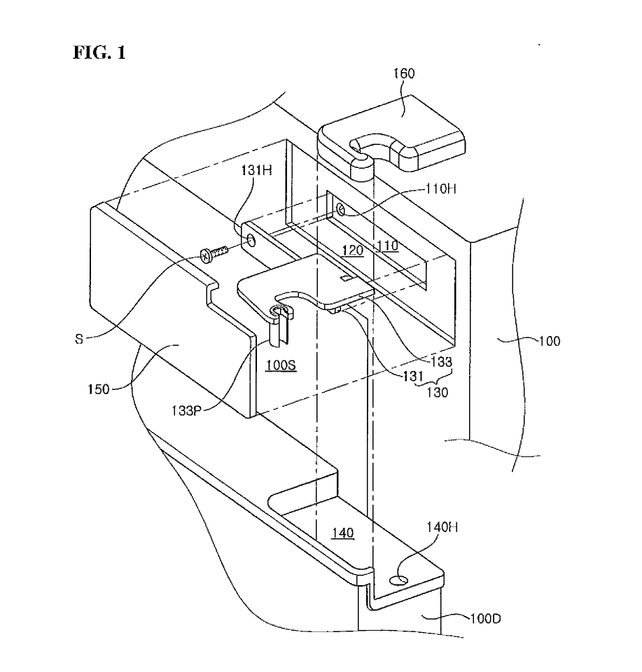

FIG. 1 is an exploded perspective view showing a preferred embodiment of a door supporting device according to the present invention.

As shown in the figure, a first seating recess 110 is formed on an upper portion of one side on a front surface of a refrigerator main body 100 in which a predetermined storage space 100S is provided. The first seating recess 110 is formed by rearward depressing a portion of a front surface of the main body 100. A pair of coupling holes 110H are formed in a surface of the seating recess 110. Further, a second seating recess 120 is formed by rearward depressing a portion of the front surface of the main body 100 including the seating recess 110. That is, a portion of the front surface of the main body 100 is depressed rearward to form the second seating recess 120, and a portion of the front surface of the second seating recess 120 is depressed rearward to form the first seating recess 110.

In addition, a hinge plate 130 is secured to the upper portion of one side on the front surface of the main body 100. The hinge plate 130 is provided to pivotally support a door 100D to be explained below, and comprises a fixing portion 131 secured to the front surface of the main body 100 and an extending portion 133 extending forward from the front surface of the fixed portion 131.

The fixing portion 131 is placed in the first seating recess 110, and a pair of through holes 131P are formed in the fixing portion 131. Screws S are inserted through the through holes 131P to secure the fixing portion 131 onto the main body 100, and the through holes are formed at positions corresponding to the coupling holes 110H. Further, in a state where the fixing portion 131 is securely seated in the first seating recess 110, the screws S are threaded into the coupling holes 101H through the through holes 131P.

A hinge pin 133P is provided on a bottom surface of the extending portion 133. The hinge pin 133P extends a predetermined length downwardly from the bottom surface of the extending portion 133. The hinge pin 133P is inserted into a hinge hole 140H to be described below in a state where the bottom surface of the extending portion 133 is brought into close contact with a floor surface of an installing recess 140 to be described later.

In addition, front and upper covers 150 and 160 are provided to cover the fixing and extending portions 131 and 133. The front cover 150 serves to cover the fixing portion 131 in a state where the fixing portion 131 is securely seated in the first seating recess 110. The front cover 150 is substantially seated in the second seating recess 120. At this time, it is preferred that the front cover 150 is placed such that a front surface of the front cover 150 is flush with the front surface of the main body 100. That is, a depth of the second seating recess 120 is preferably the same as a depth of the front cover 150. In addition, the upper cover 160 serves to cover the extending portion 133. Therefore, the front cover 150 is substantially placed between the main body 100 and the door 100D, and the upper cover 160 is placed in the installing recess 140 to be described later. As a result, the hinge plate 130 is not exposed to the outside of the refrigerator.

Furthermore, the door 100D is provided to selectively open or close the storage space 100S of the main body 100. The installing recess 140 is formed at one side of an upper surface of the door 100D. The hinge hole 140H into which the hinge pin 133P is inserted is formed on the floor surface of the installing recess 140. In addition, in a state where the hinge pin 133P is inserted in the hinge hole 140H, the extending portion 133 and the upper cover 160 are placed in the installing recess 140 and the upper surface of the door 140D is flush with an upper surface of the main body 100.

Although not shown in the figures, one side of a lower surface of the door 100D is also supported by an additional door supporting device. Such a constitution provided at the lower surface of the door 100D to support the door is the same as that of the conventional door supporting device, and thus, a detailed description thereof is omitted herein.

Hereinafter, a process of assembling the door supporting device for a refrigerator according to the preferred embodiment of the present invention will be described in more detail with reference to the accompanying drawings.

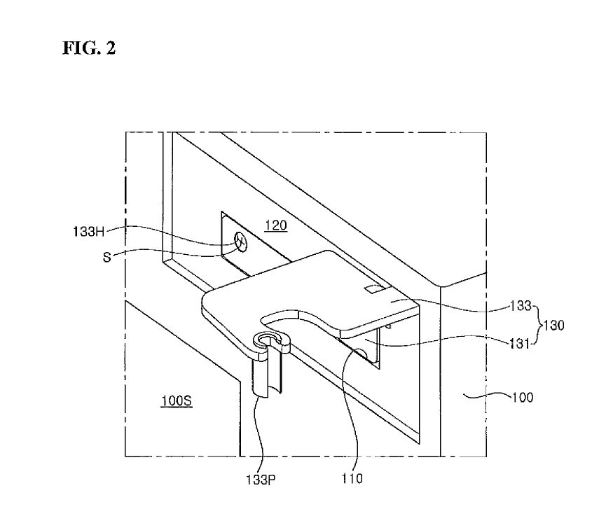

FIGS. 2 to 5 are views illustrating an operating process of assembling the preferred embodiment of the present invention.

As shown in FIG. 2, the fixing portion 131 of the hinge plate 130 is first securely seated in the first seating recess 110 of the refrigerator main body 100. Then, the screws S are threaded into the coupling holes 110H of the first seating recess 110 through the through holes 131P of the fixing portion 131 to secure the hinge plate 130 onto the front surface of the main body 100.

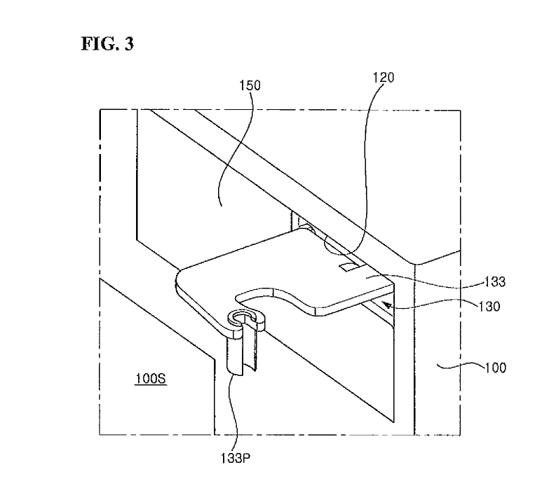

Next, as shown in FIG. 3, the front cover 150 is fixed to the front surface of the main body 100 to cover the first seating recess 110 and the fixing portion 131. At this time, the front cover 150 is securely seated in the second seating recess 120, so that the front surface of the front cover is flush with the front surface of the main body 100. Further, the extending portion 133 of the hinge plate 130 passes through a portion of the front cover 150 and extends a predetermined length forward of the main body 100.

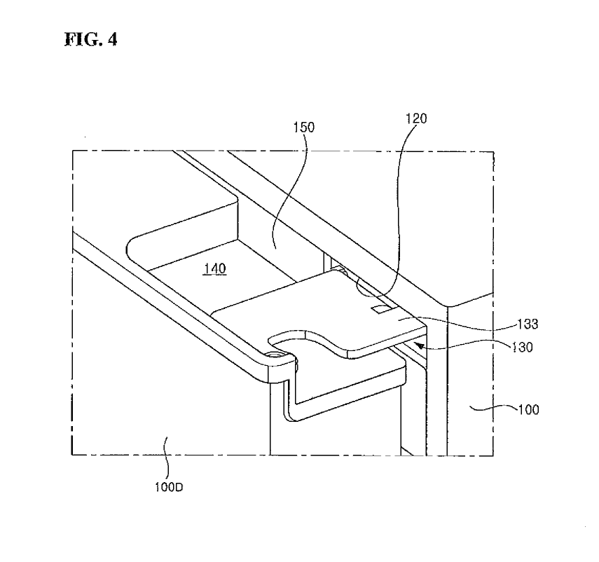

Further, as shown in FIG. 4, the hinge pin 133P of the extending portion 133 is inserted into the hinge hole 140H formed in the installing recess 140 of the refrigerator door 100D. Thus, the door 100D is installed to pivot on the binge pin 133P in a front and rear direction of the main body 100 to open or close the storage space 100S. Further, when the door 100D closes the storage space 100S, the front cover 150 is not exposed to the outside.

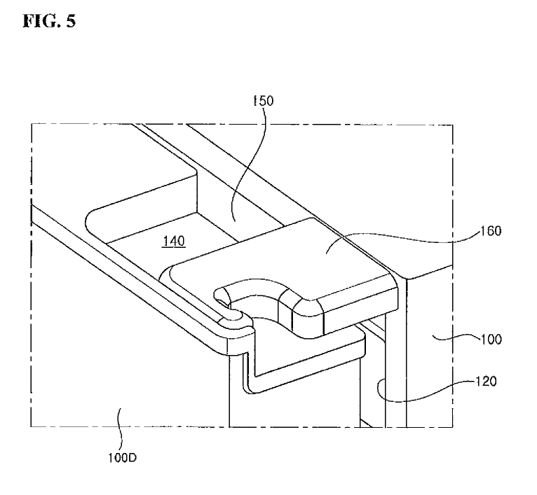

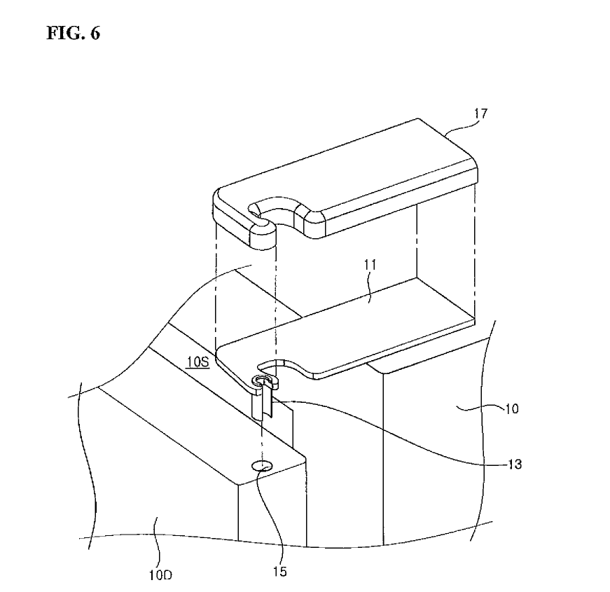

Meanwhile, as shown in FIG. 5, the upper cover 160 is secured to one side of the main body 100 to cover the extending portion 133 in a state where the door 100D is installed. At this time, since the upper cover 160 is substantially placed within the installing recess 140 of the door 100D, the upper cover is not exposed toward the front of the refrigerator.

In the illustrated embodiment, the hinge plate 130, the front cover 150 and the upper cover 160 are placed within the installing recess 140 which is formed by depressing a portion of the upper surface of the door 100D, and thus, the hinge plate 130, the front cover 150 and the upper cover 160 are substantially covered by the door 100D adjacent to the installing recess 140. That is, a portion of the upper surface of the door 100D is depressed downward with respect to the other portion of the door such that the door can cover the hinge plate 130, the front cover 150 and the upper cover 160.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

A door supporting device for a refrigerator and a refrigerator including the same according to the present invention so configured has the following advantages.

First, since parts constituting a hinge assembly are not exposed to the outside of the refrigerator, a front external appearance of the refrigerator can be simplified and thus the whole sense of beauty for the refrigerator can be enhanced.

Further, since the binge assembly is prevented from being damaged while carrying or installing the refrigerator, durability of the article can be increased.

1-13. (canceled)

14. A door supporting device for a refrigerator including a main body formed with a predetermined storage space therein and a door for selectively opening or closing the storage space, comprising:
a hinge plate fixed to one side of a front surface of the main body and having a downwardly extending hinge pin; and
an installing recess formed by inwardly depressing a portion of an upper surface of the door by a predetermined depth and formed with a hinge hole therein,
wherein the hinge plate is securely seated in the installing recess in a state where the hinge pin is inserted into the hinge hole.

15. The door supporting device as claimed in claim 14, wherein the hinge plate comprises:
a fixing portion secured to one side of the front surface of the main body; and
an extending portion extending forward from a front surface of the fixing portion and formed with the hinge pin on a surface thereof,
wherein the fixing portion and the extending portion are placed within the installing recess.

16. A door supporting device for a refrigerator including a main body formed with a predetermined storage space therein and a door for selectively opening or closing the storage space, comprising:
a hinge plate fixed to one side of a front surface of the main body and having a downwardly extending hinge pin; and
a covering section formed by causing a portion of an upper surface of the door to protrude upwardly to prevent the hinge plate from being exposed forward of the door in a state where the hinge pin is inserted into a hinge hole formed at one side of the upper surface of the door.

17. The door supporting device as claimed in claim 16, wherein other portions of the door than a portion of the upper surface of the door brought into close contact with the hinge plate and portions adjacent to the portion brought into close contact with the hinge plate protrude upwardly to thereby form the covering section.

18. The door supporting device as claimed in claim 17, wherein the hinge plate comprises:
a fixing portion secured to one side of the front surface of the main body; and
an extending portion extending forward from a front surface of the fixing portion and formed with the hinge pin on a surface thereof,
wherein the fixing portion and the extending portion are placed within the installing recess.

19. The door supporting device as claimed in claim 14 or 16, further comprising a front cover for covering the fixing portion of the hinge plate.

20. The door supporting device as claimed in claim 19, wherein the main body is formed with first and second seating recesses on a front surface thereof, the fixing portion is seated in the first seating recess, and the front cover is seated in the second seating recess in which the first seating recess is defined.

21. The door supporting device as claimed in claim 14 or 16, further comprising an upper cover for covering the extending portion of the hinge plate.

22. A refrigerator, comprising:
a main body formed with a predetermined storage space therein;
a door for selectively opening or closing the storage space; and
a door supporting device according to claim 14 or 16 for pivotally supporting the door on the main body.

23. The refrigerator as claimed in claim 22, wherein the door supporting device further comprises:
a front cover for covering the fixing portion of the hinge plate; and
an upper cover for covering the extending portion of the hinge plate.

24. The refrigerator as claimed in claim 23, wherein the fixing portion is securely seated in a first seating recess formed by relatively rearward depressing a portion of a front surface of the main body.

25. The refrigerator as claimed in claim 24, wherein a front surface of the front cover is flush with a front surface of the main body when the front cover is seated in a second seating recess formed by relatively rearward depressing a portion of a front surface of the main body including the first seating recess.

26. The refrigerator as claimed in claim 25, wherein the storage space defined in the main body is formed into a pair of storage spaces partitioned from side to side, and the door is pivoted in a front and rear direction by the door supporting device in such a state that a free end thereof is opposite to a free end of the other door.
